(19) United States
(12) Patent Application Publication
(10) Pub. No.: US 2015/0014974 A1
(43) Pub. Date: Jan. 15, 2015

(54) WHEELED VEHICLE HAVING A SIDE DOOR AND A FLEXIBLE LATERAL COVER

(71) Applicants: BOMBARDIER RECREATIONAL PRODUCTS INC., Valcourt (CA); BRP US INC., Sturtevant, WI (US)

(72) Inventors: Thierry Cotnoir, Sherbrooke (CA); Charles Roy, Orford (CA)

(21) Appl. No.: 14/389,327

(22) PCT Filed: Mar. 28, 2013
(86) PCT No.: PCT/US13/34384

§ 371 Date: Sep. 29, 2014

Related U.S. Application Data
(60) Provisional application No. 61/618,175, filed on Mar. 30, 2012.

(51) Int. Cl. B60R 21/13; B60J 5/04

(52) U.S. Cl. CPC B60R 21/13; B60J 5/0487
USPC 280/756

(57) ABSTRACT

A vehicle has a frame, a cockpit area, a roll cage, two seats disposed side-by-side, an engine, four wheels, a steering has device, and two lateral sides. Each of the two lateral sides h a lateral passage disposed adjacent to one of the two seats. A door has front and rear sides. The rear side of the door is pivotally connected to one of the two lateral sides. The door is pivotable between a first position where the door closes the lateral passage corresponding to the one of the two lateral sides and a second position where the door opens the lateral passage corresponding to the one of the two lateral sides. A flexible lateral cover has an upper end connected to the roll cage, and a lower end connected to the door and movable with the door between the first and second positions of the door.

### CROSS-REFERENCE

The present application claims priority from U.S. Provisional Patent Application No. 61/618,175, filed Mar. 30, 2012, the entirety of which is incorporated herein by reference.

### TECHNICAL FIELD

The present invention relates to a four-wheeled vehicle having an open cockpit area, a side door and a flexible lateral cover.

### BACKGROUND

Recreational utility vehicles (RUVs) generally have an open cockpit area with side-by-side seating. They are often referred to as side-by-side All-Terrain Vehicles (ATVs) or side-by-side vehicles (SSVs).

The open cockpit area is protected by a roll cage disposed above the cockpit area. The driver and the passenger enter and exit (ingress and egress) the vehicle through open lateral passages.

These open lateral passages can permit the entry of dirt and/or water inside the cockpit area and onto the driver and passenger.

Therefore, there is a need for a system that would contribute to protecting the driver and the passenger from the entry of dirt and/or water by the lateral passages while keeping the enjoyment of riding an off-road vehicle without the constraints of a fully enclosed cabin.

### SUMMARY

It is an object of the present invention to ameliorate at least some of the inconveniences of the prior art.

In one aspect, a vehicle provides a frame, a cockpit area defined in the frame, a roll cage connected to the frame, the roll cage covering at least in part the cockpit area, two seats disposed side-by-side in the cockpit area, the two seats being covered by the roll cage, each of the two seats being adapted to support a rider, an engine supported by the frame, two front wheels and two rear wheels supported by the frame, at least two of the wheels being operatively connected to the engine for propelling the vehicle, a steering device disposed generally forward of the two seats, the steering device being operatively connected to at least two of the wheels for steering the vehicle, and two lateral sides. The cockpit area is disposed between the two lateral sides. Each of the two lateral sides comprises a lateral passage disposed adjacent to one of the two seats. Each of the two lateral passages is adapted to allow ingress and egress of a rider to and from the cockpit area. A door has a front side and a rear side. The rear side of the door is pivotally connected to one of the two lateral sides. The door is pivotable between a first position where the door closes the lateral passage corresponding to the one of the two lateral sides and a second position where the door opens the lateral passage corresponding to the one of the two lateral sides. A flexible lateral cover has an upper end connected to the roll cage and a lower end connected to the door. The lower end of the flexible lateral cover is movable with the door between the first and second positions of the door.

In a further aspect, at least one hinge pivotally connects the rear side of the door to the one of the two lateral sides.

In an additional aspect, the door is pivotally connected to the one of the two lateral sides about a generally vertical axis.

In a further aspect, the upper end of the flexible lateral cover is disposed rearwardly of the generally vertical axis.

In an additional aspect, the flexible lateral cover is made of a plurality of flexible straps and at least one flexible panel connected to the plurality of flexible straps.

In a further aspect, the at least one flexible panel is at least one mesh panel.

In a additional aspect, the upper end of the flexible lateral panel is connected to a generally horizontal member of the roll cage and to a generally vertical member of the roll cage.

In a further aspect, the generally vertical member of the roll cage is disposed rearwardly of the door.

In an additional aspect, the rear side of the door is pivotally connected to the frame.

In a further aspect, a latch selectively connects the front side of the door to the one of the two lateral sides for locking the door in the first position of the door.

In an additional aspect, a cargo box is connected to the frame and is disposed rearwardly of the two seats.

In a further aspect, the cargo box is pivotally connected to the frame.

In an additional aspect, the flexible lateral cover has at least one elastic element.

In a further aspect, the at least one elastic element connects the flexible lateral cover to the door.

In an additional aspect, the at least one elastic element includes a band of elastic material.

In a further aspect, the at least one elastic element further includes a flexible strap forming at least one loop with the band of elastic material.

For purposes of this application the term “recreational utility vehicle” (RUV) refers to an “opened” wheeled vehicle (contrary to a pickup truck which is a “closed” vehicle due to its closed passenger cabin) designed for off-road use which usually has side-by-side seating.

The term ‘mesh’ refers to a material that has a plurality of apertures to allow wind flow through it. In some cases, the mesh material is see-through. The apertures of the mesh material can have various shapes and sizes. The mesh material does not need to be a unitary piece of fabric. For example, a mesh material could be formed of several pieces arranged in a grid.

The term ‘flexible’ refers to a material that is non rigid, that is capable of bending. A flexible material may accept some deformation.

Also, terms related to spatial orientation such as forwardly, rearwardly, front, rear, upper, lower, left, and right, are as they would normally be understood by a driver of the vehicle sitting therein in a normal driving position.

Embodiments of the present invention each have at least one of the above-mentioned aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

Further features and advantages of the present invention will become apparent from the following detailed description, taken in combination with the appended drawings, in which:

FIG. 1 is a left side elevation view of a RUV, with fairings partially removed for clarity, having a flexible lateral cover and a driver's side door in a closed position;

FIG. 2 is a top plan view of the RUV of FIG. 1;

FIG. 3 is a left side elevation view of the RUV of FIG. 1 with the driver's side door in an opened position and with the passenger's side door and flexible lateral cover removed for clarity;

FIG. 4 is a left side elevation view of an alternative embodiment of a flexible lateral cover for the RUV of FIG. 1; and

FIG. 5 is a right side elevation view of the flexible lateral cover of FIG. 4 connected to the driver's side door of the RUV of FIG. 1.

### DETAILED DESCRIPTION

The present side door and flexible lateral cover will be described with respect to a recreational utility vehicle (RUV). However it should be understood that they could be used on other types of off-road vehicles having an open cockpit area.

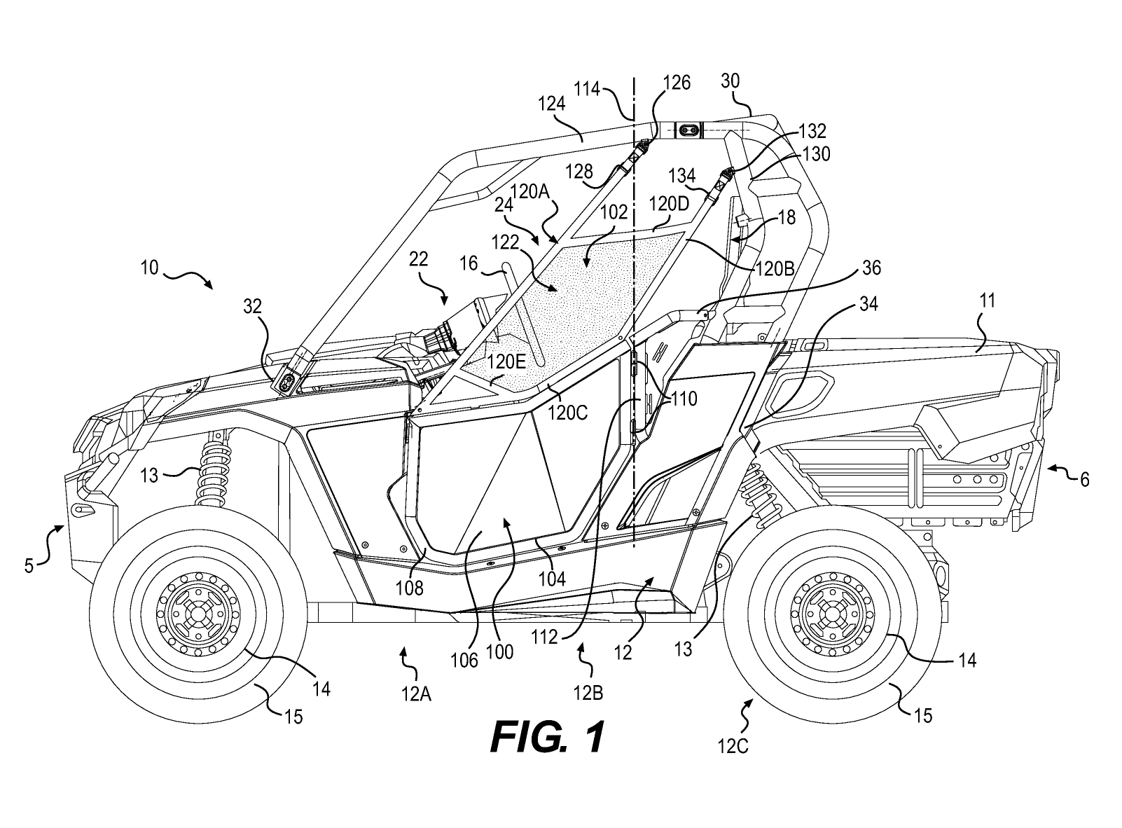

FIGS. 1 to 3 illustrate an RUV 10 having a front end 5 a rear end 6, and two lateral sides 7 (left and right). The RUV 10 includes a frame 12 to which a vehicle body is mounted. The frame 12 has a front portion 12A, a middle portion 12B and a rear portion 12C. A pair of front wheels 14 is suspended from the front portion 12A of the frame 12 via front suspensions 13. A pair of rear wheels 14 is suspended from the rear portion 12C of the frame 12 via rear suspensions 13. Each of the four wheels 14 has a tire 15. It is contemplated that the RUV 10 could have six or more wheels. A cockpit area 22 is disposed in the middle portion 12B of the frame 12. The cockpit area 22 comprises two seats 18 (left and right). Each seat 18 has a seat base 17 and a backrest 19. The seats 18 are mounted laterally beside each other to accommodate a driver and a passenger (riders) of the RUV 10. The seats 18 are bucket seats. It is contemplated that the seats 18 could be other types of recumbent seats. The cockpit area 22 has openings at the two lateral sides 7 of the RUV 10, forming two lateral passages 24 (left and right), through which the riders can ingress and egress the RUV 10.

A roll cage 30 is connected to the frame 12 and is disposed above the cockpit area 22. The roll cage 30 is an arrangement of metal tubes which contributes to protecting the riders in the event the vehicle rolls over. The roll cage 30 has several attachment points to the frame 12. Toward the front 5 of the RUV 10, the roll cage 30 connects to the frame 12 at front attachment points 32 (left and right). The front attachment points 32 are located longitudinally between a roll axis of the front wheels 14 and a forwardmost point of the seats 18. Toward the rear 6 of the RUV 10, the roll cage 30 connects to the frame 12 at rear attachment points 34 (left and right). The rear attachment points 34 are located longitudinally between a roll axis of the rear wheels 14 and the a rearwardmost point of the seat base 17 of the seats 18. The roll cage 30 connects to a pair of lateral restraining members 36, one on each side of a rear part of the roll cage 30. The lateral restraining members 36, which form part of the frame 12, extend forward from the rear part of the roll cage 30. The lateral restraining members 36 protect an upper body of the riders during leaning or roll-over. It is contemplated that the restraining members 36 could be omitted.

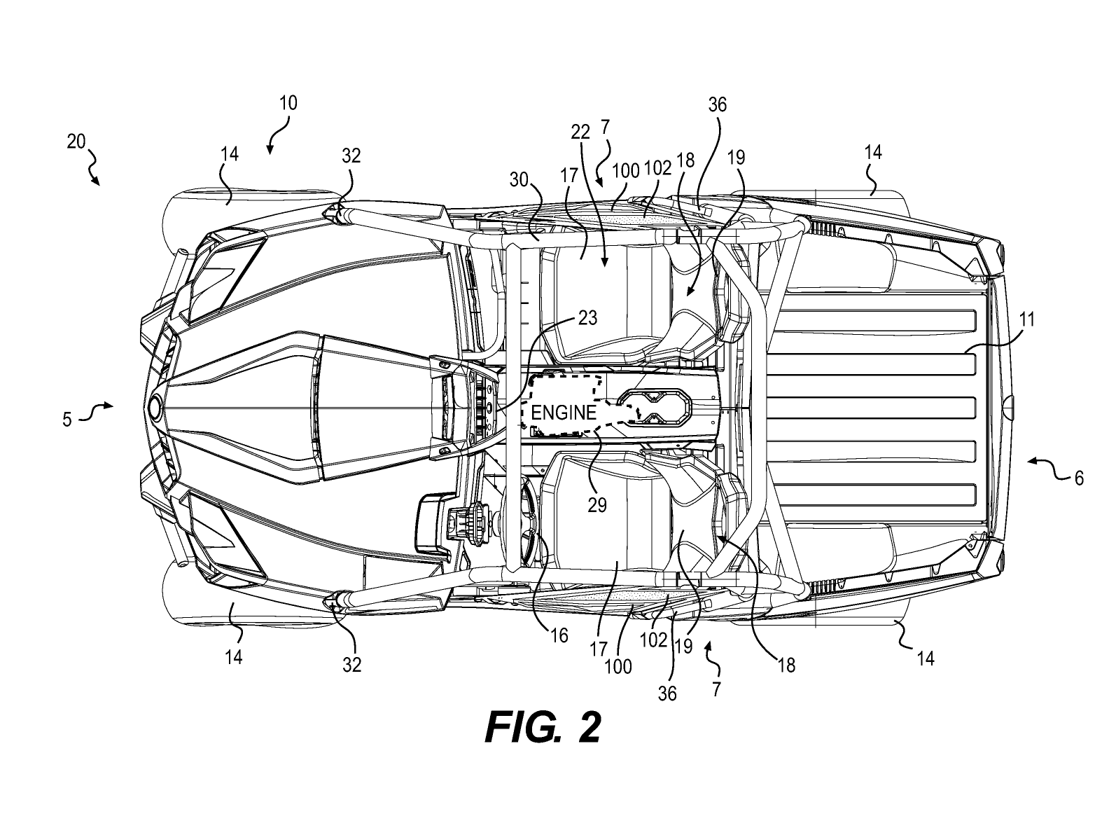

A steering assembly 16, including a steering wheel, is disposed in front of the left seat 18. It is contemplated that, the steering wheel could be disposed in front of the right seat 18. The steering assembly 16 is operatively connected to the two front wheels 14 to permit steering of the RUV 10. An engine 29, shown schematically in dotted lines in FIG. 2, is mounted to the middle portion 12B of frame 12 between the right and the left seats 18. The engine 29 is operatively connected to the four wheels 14 to power the RUV 10. It is contemplated that the engine 29 could be operatively connected only to the front wheels 14 or only to the rear wheels 14. A cargo box 11 is pivotally mounted to the frame 12 rearwardly of the seats 18. It is contemplated that the cargo box 11 could be omitted. A console 23, positioned between the right and left seats 18 covers and separates the engine 29 from the driver and the passenger. The RUV 10 has other features and components such as headlights and handles. As it is believed that these features and components would be readily recognized by one of ordinary skill in the art, further explanation and description of these components will not be provided herein.

Side doors 100 are provided in the lower portions of the lateral passages 24 to open and close the lateral passages 24. Flexible lateral covers 102 extend between the roll cage 30 and the tops of the doors 100 to selectively cover the upper portions of the lateral passages 24. It is contemplated that only one of the two lateral passages 24 could be provide with a door 100 and/or a flexible lateral cover 102. When the riders are riding the RUV 10, the side doors 100 are intended to be closed and as a result, the flexible lateral covers 102 extend generally vertically across the lateral passages 24. When the riders desire either ingress or egress the cockpit area 22, the doors 100 are opened and as a result, the lower ends of the flexible lateral covers 102 move with the doors 100 to clear the lateral passage 24.

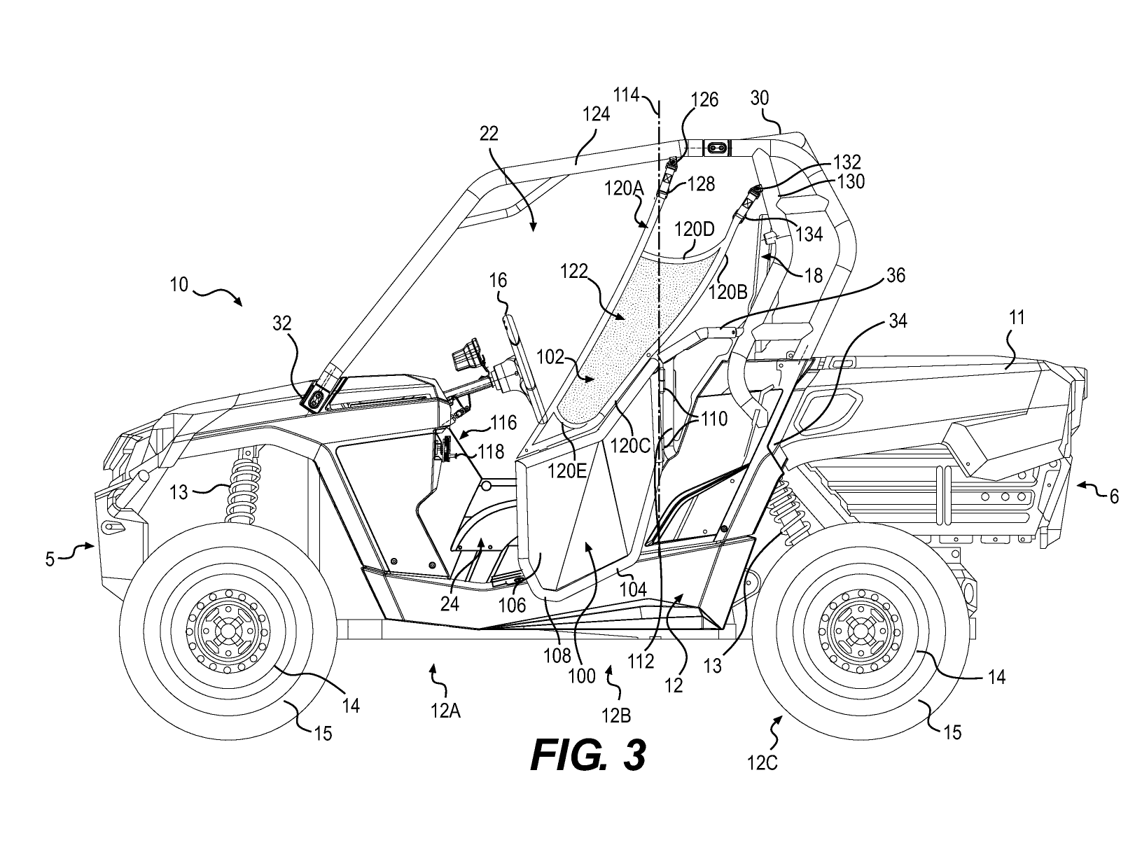

The doors 100 and flexible lateral covers 102 will now be described in more detail with respect to FIGS. 1 and 3. Since the passenger's side door 100 and flexible lateral cover 102 are mirror images of the driver's side door 100 and flexible lateral cover 102, only the driver's side door 100 and flexible lateral cover 102 will be described herein. It is contemplated that the driver's side and passenger's side doors 100 and flexible lateral covers 102 could differ from each other.

The door 100 includes a door frame 104 and a body panel 106 connected to the door frame 106. The door frame 104 is made of metal tubes. The door frame 104 has a peripheral portion 108 defining a periphery of the door 100. It is contemplated that the door frame 104 could have one or more cross-members extending inside the peripheral portion 108. As can be seen, the upper edge of the door 100 is generally V-shaped and is higher than the seat base 17 of the driver's seat 18. The above description is only one possible construction of the door 100, and other types of constructions are contemplated.

The rear side of the door frame 104 is pivotally connected by two hinges 110 to a generally vertically oriented frame member 112 of the lateral restraining member 36 of the frame 12 on the lateral side 7 of the vehicle 10. The hinges 110 define a vertical axis 114 about which the door fame 104 and body panel 106 pivot between the closed position of the door 100 shown in FIG. 1 where the door 100 closes the lateral passage 24 and a plurality of opened positions of the door 100, one of which is shown in FIG. 3, where the door 100 opens the lateral passage. It is contemplated that only one or more than two hinges 110 could be provided. It is also contemplated that the axis 114 could be, for example, plus or minus 20 degrees off the vertical (i.e. generally vertical) such that the door 100 has a natural tendency to move toward one of the closed or opened positions, depending on the orientation of the axis 114.

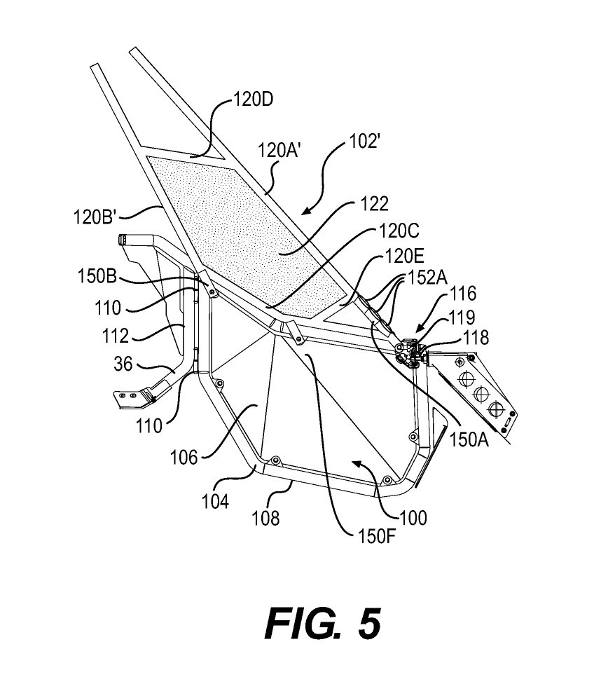

A latch 116 (FIG. 3) is used to lock the door 100 in the closed position shown in FIG. 1. The latch 116 includes a pin 118 and a catch 119 (FIG. 5). The pin 118 is connected to the frame 12 on the lateral side 7 of the vehicle 10 near a front of the lateral passage 24. The catch 119 is connected to the front side of the door. When the door 100 is closed, the catch 119 engages the pin 118, thereby connecting the front side of the door 100 to the lateral side 7 and locking the door 100 in the closed position. To open the door 100, the rider pushes on the door 100 to disengage the catch from the pin 118, thus allowing the door 100 to be opened. It is contemplated that the door 100 could be provided with one door handle on the inside of the door 100 to be actuated by the rider when the rider is sitting in the vehicle 10 and another door handle on the outside of the door 100 to be actuated by the rider when the rider is outside the vehicle 10 or with only one of these two door handles.

The flexible lateral cover 102 is made of flexible straps 120A to 120E and a flexible panel 122 connected to the straps 120A to 120E. The flexible straps 120A to 120E are polyester straps, but other materials are contemplated. The flexible panel 122 is a mesh panel that is disposed in the area defined by the straps 120A to 120E and is sown to the straps 120A to 120E. It is contemplated that the panel 122 could be made in whole or in part by different flexible materials. It is contemplated that a different number of flexible straps could be provided and that more than one flexible panel 122 could provided. It is also contemplated that the flexible panel 122 could be omitted and replaced by additional flexible straps such that the empty areas between the straps are relatively small so as to prevent a driver's hand, arm or head to pass through these areas.

The flexible strap 120A has a lower end connected to the top part of the door frame 104 at a front thereof. The flexible strap 120A has an upper end connected to a generally horizontal member 124 of the roll cage 30. As can be seen in the figures, the upper end of the flexible strap 120A is disposed rearwardly of the vertical axis 114 about which the door 100 is pivotable. The upper end of the flexible strap 120A is connected to the generally horizontal member 124 via a strap connector 126 that is pivotally connected to the generally horizontal member 124. The strap 120A is looped through the strap connector 126. A buckle 128 is provided on the strap 120A near the upper end thereof. The buckle 128 allows the tension in the strap 120A to be adjusted. When the door 100 is closed as shown in FIG. 1, from its lower end, the flexible strap 120A extends diagonally rearwardly and upwardly to its upper end.

The flexible strap 120B has a lower end connected to the top part of the door frame 104 at a rear thereof. The flexible strap 120B has an upper end connected to a generally vertical member 130 of the roll cage 30. The generally vertical member 130 of the roll cage 30 is disposed rearwardly of the door 100. As can be seen in the figures, the upper end of the flexible strap 120B is disposed rearwardly of the upper end of the flexible strap 120A. The upper end of the flexible strap 120B is connected to the generally vertical member 130 via a strap connector 132 that is pivotally connected to the generally vertical member 130. The strap 120B is looped through the strap connector 132. A buckle 134 provided on the strap 120B near the upper end thereof allows the tension in the strap 120B to be adjusted. When the door 100 is closed as shown in FIG. 1, from its lower end, the flexible strap 120B extends diagonally rearwardly and upwardly to its upper end.

The flexible strap 120C extends along the top part of the door frame 104 and is connected to it in multiple locations. The front end of the flexible strap 120C is connected to the lower end of the flexible strap 120A. The rear end of the flexible strap 120C is connected to the lower end of the flexible strap 120B.

The flexible strap 120D extends between the flexible straps 120A and 120B. The front end of the flexible strap 120D is connected to the flexible strap 120A. The rear end of the flexible strap 120D is connected to the flexible strap 120B. When the door 100 is closed as shown in FIG. 1, from its front end, the flexible strap 120D extends rearwardly and slightly upwardly to its rear end and is disposed higher than the steering wheel.

The flexible strap 120E extends between the flexible straps 120A and 120C. The front end of the flexible strap 120E is connected to the flexible strap 120A near a lower end thereof. The rear end of the flexible strap 120E is connected to the flexible strap 120C near a center thereof. When the door 100 is closed as shown in FIG. 1, from its front end, the flexible strap 120E extends rearwardly and downwardly to its rear end.

The tension in the straps 120A and 120B is adjusted such that when the door 100 is closed as shown in FIG. 1, all of the straps 120A to 120E and the flexible panel 122 are relatively taut. Some slack is maintained in the straps 120A to 120E when the door 100 is closed so as to allow for the opening of the door 100.

As can be seen in FIG. 3, when the door 100 is opened, the lower end of the flexible lateral cover 102 swings away from lateral passage 24 with the door 100 while the upper end of the flexible lateral cover 102 remains connected to the roll cage 30. As a result, some of the flexible straps 120A, 120B, 120D and 120E become tauter such that the flexible lateral cover 102 also becomes tauter. As such, when the door 100 is opened, the flexible lateral cover 102 clears the lateral passage 24 sufficiently to allow the ingress or egress of a rider to or from the cockpit area 22.

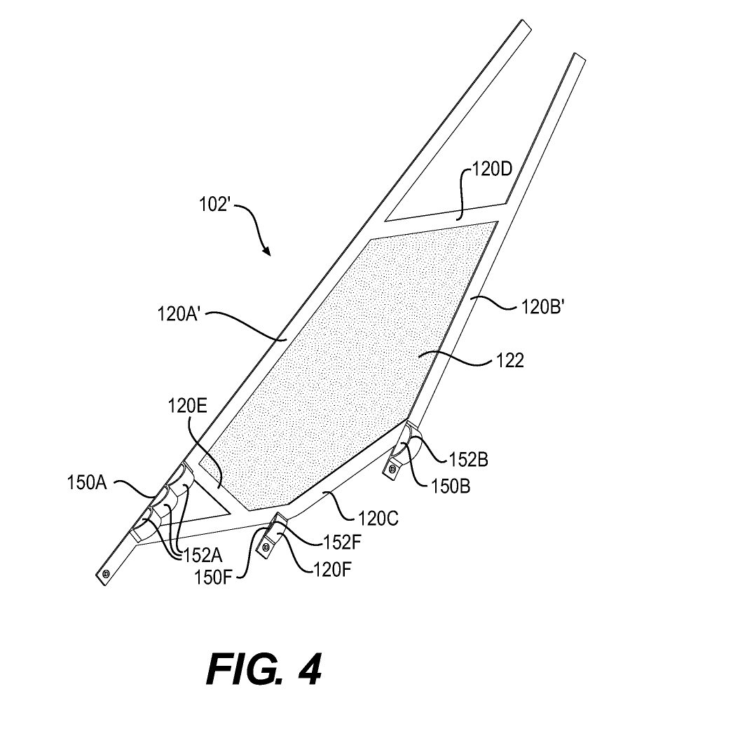

Turning now to FIGS. 4 and 5, a flexible lateral cover 102′, which is an alternative embodiment of the flexible lateral cover 102 described above, will be described. For simplicity, elements of the flexible lateral cover 102′ that are similar to those of the flexible lateral cover 102 have been labeled with the same reference numbers and will not be described again.

In the flexible lateral cover 102′, the straps 120A and 120B have been replaced with a straps 120A′ and 120B′ respectively, described below. The straps 120C to 120E and the flexible panel 122 are the same. It should be noted that although not shown, the upper ends of the straps 120A′ and 120B′ are provided with strap connectors and buckles similar to the strap connectors 126, 132 and buckles 128, 134 of the flexible lateral cover 102.

A band of elastic material 150A is sewn or otherwise connected to the inner side of the strap 120A′ so as to extend at least between the straps 120C and 120E. The portion of the strap 120A′ disposed between the straps 120C and 120E is sewn or otherwise connected to the band of elastic material 150A such that three loops 152A are formed between the strap 120A′ and the band of elastic material 150A. It is contemplated that the band of elastic material 150A and the loops 152A could be located elsewhere along the length of the strap 120A′. It is also contemplated that there could be more or less than three loops 152A. It is also contemplated that the band of elastic material 150A could be sewn or otherwise connected to the outer side of the strap 120A′ such that the loops 152A are formed on the inner side of the strap 120A′. The strap 120A′ extends below the strap 120C and is connected to the inner side of the door frame 104 as can be seen in FIG. 5. It is also contemplated that the portion of the strap 120A′ extending below the strap 120C could be separate strap sewn or otherwise connected to the lower end of the strap 120A′. It is also contemplated that the portion of the strap 120A′ extending below the strap 120C and the portion of the strap 120A′ forming the loops 152A could be a separate strap sewn or otherwise connected to a remainder of the strap 120A′.

The strap 120B′ extends below the strap 120C and is connected to the inner side of the door frame 104 as can be seen in FIG. 5. A band of elastic material 150B is sewn or otherwise connected to the inner side of the lower portion of the strap 120B′. The lower portion of the strap 120B′ is sewn or otherwise connected to the band of elastic material 150B such that one loop 152B is formed between the strap 120B′ and the band of elastic material 150B. It is contemplated that the band of elastic material 150B and the loop 152B could be located elsewhere along the length of the strap 120B′. It is also contemplated that there could be more than one loop 152B. It is also contemplated that the band of elastic material 150B could be sewn or otherwise connected to the outer side of the strap 120B′ such that the loop 152B is formed on the inner side of the strap 120B′. It is also contemplated that the portion of the strap 120B′ extending below the strap 120C and the portion of the strap 120B′ forming the loop 152B could be a separate strap sewn or otherwise connected to a remainder of the strap 120B′.

A strap 120F is sewn or otherwise connected to the strap 120C near a longitudinal center thereof. The strap 120F extends below the strap 120C and is connected to the inner side of the door frame 104 as can be seen in FIG. 5. A band of elastic material 150F is sewn or otherwise connected to the inner side of the strap 120F. The strap 120F is sewn or otherwise connected to the band of elastic material 150F such that one loop 152F is formed between the strap 120F and the band of elastic material 150F. It is contemplated that the band of elastic material 150F and the loop 152F could be located elsewhere along the length of the strap 120C. It is also contemplated that there could be more than one strap 120F and one band of elastic material 150F forming a loop 152F connected to the strap 120C. It is also contemplated that the strap 120F and the band of elastic material 150F could be omitted. It is also contemplated that there could be more than one loop 152F formed by the strap 120F and the band of elastic material 150F. It is also contemplated that the band of elastic material 150F could be sewn or otherwise connected to the outer side of the strap 120F such that the loop 152F is formed on the inner side of the strap 120F.

The bands of elastic materials 150A, 150B and 150F are made of fabric woven with elastic bands similar to sewing elastics. It is contemplated that the bands of elastic materials 150A, 150B and 150F could be made of other materials that can be returned to their original length after having been stretched such as for example, but not limited to, elastane for example.

By forming the loops 152A, 152B and 152F with the straps 120A′, 120B′, and 120F respectively, the bands of elastic materials 150A, 150B and 150F can be stretched, but the amount of stretch is limited by the straps 120A′, 120B′, and 120F. It is contemplated that the combination of bands of elastic material and straps forming loops could be replaced by other types elastic elements that can withstand forces similar to the straps 120A′, 120B′ and 120F once a certain amount of stretching has been reached. For example, certain types of bungee cords could be used to replace the combination of bands of elastic material and straps forming loops of the flexible lateral cover 102′.

In a RUV 10 provided with flexible lateral covers 102′, when the door 100 is opened, the lower end of the flexible lateral cover 102′ swings away from lateral passage 24 with the door 100 while the upper end of the flexible lateral cover 102′ remains connected to the roll cage 30. As a result, some of the bands of elastic materials 150A, 150B and 150F stretch. When the door 100 is closed, the bands of elastic materials 150A, 150B and 150F return to their original lengths thereby keeping the flexible lateral cover 102′ taut.

Modifications and improvements to the above-described embodiment of the present invention may become apparent to those skilled in the art. The foregoing description is intended to be exemplary rather than limiting. The scope of the present invention is therefore intended to be limited solely by the scope of the appended claims.

What is claimed is:

1. A vehicle comprising:
a frame;
a cockpit area defined in the frame;
a roll cage connected to the frame, the roll cage covering at least in part the cockpit area;
two seats disposed side-by-side in the cockpit area, the two seats being covered by the roll cage, each of the two seats being adapted to support a rider;
an engine supported by the frame;
two front wheels and two rear wheels supported by the frame, at least two of the wheels being operatively connected to the engine for propelling the vehicle;
a steering device disposed generally forward of the two seats, the steering device being operatively connected to at least two of the wheels for steering the vehicle;
two lateral sides, the cockpit area being disposed between the two lateral sides, each of the two lateral sides comprising a lateral passage disposed adjacent to one of the two seats, each of the two lateral passages being adapted to allow ingress and egress of a rider to and from the cockpit area;
a door having a front side and a rear side, the rear side of the door being pivotally connected to one of the two lateral sides, the door being pivotable between a first position where the door closes the lateral passage corresponding to the one of the two lateral sides and a second position where the door opens the lateral passage corresponding to the one of the two lateral sides; and
a flexible lateral cover having an upper end connected to the roll cage and a lower end connected to the door, the lower end of the flexible lateral cover being movable with the door between the first and second positions of the door.

2. The vehicle of claim 1, further comprising at least one hinge pivotally connecting the rear side of the door to the one of the two lateral sides.

3. The vehicle of claim 1, wherein the door is pivotally connected to the one of the two lateral sides about a generally vertical axis.

4. The vehicle of claim 3, wherein the upper end of the flexible lateral cover is disposed rearwardly of the generally vertical axis.

5. The vehicle of claim 1, wherein the flexible lateral cover is made of a plurality of flexible straps and at least one flexible panel connected to the plurality of flexible straps.

6. The vehicle of claim 5, wherein the at least one flexible panel is at least one mesh panel.

7. The vehicle of claim 1, wherein the upper end of the flexible lateral panel is connected to a generally horizontal member of the roll cage and to a generally vertical member of the roll cage.

8. The vehicle of claim 7, wherein the generally vertical member of the roll cage is disposed rearwardly of the door.

9. The vehicle of claim 1, wherein the rear side of the door is pivotally connected to the frame.

10. The vehicle of claim 1, further comprising a latch selectively connecting the front side of the door to the one of the two lateral sides for locking the door in the first position of the door.

11. The vehicle of claim 1, further comprising a cargo box connected to the frame and disposed rearwardly of the two seats.

12. The vehicle of claim 11, wherein the cargo box is pivotally connected to the frame.

13. The vehicle of claim 1, wherein the flexible lateral cover has at least one elastic element.

14. The vehicle of claim 13, wherein the at least one elastic element connects the flexible lateral cover to the door.

15. The vehicle of claim 14, wherein the at least one elastic element includes a band of elastic material.

16. The vehicle of claim 15, wherein the at least one elastic element further includes a flexible strap forming at least one loop with the band of elastic material.

17. The vehicle of claim 13, wherein the at least one elastic element includes a band of elastic material.

18. The vehicle of claim 17, wherein the at least one elastic element further includes a flexible strap forming at least one loop with the band of elastic material.
